(19) United States
(12) Patent Application Publication
(10) Pub. No.: US 2026/0275894 A1
(43) Pub. Date: Sep. 17, 2026

(54) CONTROLLER FOR INTERNAL COMBUSTION ENGINE, CONTROL METHOD FOR INTERNAL COMBUSTION ENGINE, AND STORAGE MEDIUM

(71) Applicant: TOYOTA JIDOSHA KABUSHIKI KAISHA, Toyota-shi (JP)

(72) Inventors: Takashi NAKAMURA, Toyota-shi (JP); Satoshi NAKAMURA, Toyota-shi (JP)

(73) Assignee: TOYOTA JIDOSHA KABUSHIKI KAISHA, Toyota-shi (JP)

(21) Appl. No.: 19/557,738

(22) Filed: Mar. 5, 2026

(30) Foreign Application Priority Data
Mar. 11, 2025 (JP) 2025-038128

(51) Int. Cl. F01N 11/00; F01N 3/021

(52) U.S. Cl. CPC F01N 11/002; F01N 3/021; F01N 2550/04

(57) ABSTRACT

A controller for an internal combustion engine, a control method for an internal combustion engine, and a storage medium are provided. A pressure sensor detects, as a pressure value, a differential pressure between an upstream section and a downstream section of an exhaust passage with respect to a filter. When it is determined that the pressure sensor is correctly detecting the pressure value, the processing circuitry calculates a reference ratio. The reference ratio is a ratio between the pressure value detected by the pressure sensor and a reference pressure. The reference pressure is calculated based on an operating parameter in a trip subsequent to a trip in which the reference ratio is stored. The pressure value is calculated by multiplying the calculated reference pressure by the stored reference ratio.

### CROSS-REFERENCE TO RELATED APPLICATIONS

This application is based upon and claims the benefit of priority from Japanese Patent Application No. 2025-038128, filed on Mar. 11, 2025, the entire contents of which are incorporated herein by reference.

### BACKGROUND

### 1. Field

The present disclosure relates to a controller for an internal combustion engine, a control method for an internal combustion engine, and a storage medium.

### 2. Description of Related Art

JP2012-184756A discloses an internal combustion engine equipped with a filter for trapping particulate matter contained in the exhaust gas, the filter being disposed in an exhaust passage. The exhaust passage includes an upstream exhaust section located upstream of the filter and a downstream exhaust section located downstream of the filter. A pressure pipe is connected to the upstream exhaust section upstream of the filter and the downstream exhaust section downstream of the filter in the exhaust passage. The pressure pipe is provided with a pressure sensor that detects, as a pressure value, a differential pressure between the pressure of the upstream exhaust section and the pressure of the downstream exhaust section. The controller disclosed in the cited document performs control of the filter based on the pressure value detected by the pressure sensor.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a controller for an internal combustion engine includes processing circuitry. The processing circuitry is configured to execute: a determination process of determining whether a pressure sensor is correctly detecting a pressure value, the internal combustion engine being mounted on a vehicle, an exhaust passage of the internal combustion engine being provided with a filter for trapping particulate matter in exhaust gas in the exhaust passage, a pressure pipe being connected to an upstream section of the exhaust passage with respect to the filter and a downstream section of the exhaust passage with respect to the filter, and the pressure sensor being disposed in the pressure pipe and configured to detect, as the pressure value, a differential pressure between a pressure of the upstream section and a pressure of the downstream section; a reference ratio storing process of calculating a reference ratio and storing the reference ratio as a value to be used in a next trip of the vehicle when it is determined in the determination process that the pressure sensor is correctly detecting the pressure value, the next trip being a trip subsequent to the trip in which the reference ratio is stored, the reference ratio being a ratio between the pressure value detected by the pressure sensor and a reference pressure that is a reference value of the pressure value, the reference pressure being calculated based on an operating parameter relating to the pressure value; and a pressure value calculation process including: calculating the reference pressure based on the operating parameter in the next trip; and calculating the pressure value by multiplying the calculated reference pressure by the stored reference ratio.

In another general aspect, a method for controlling an internal combustion engine includes: determining, by processing circuitry of a controller, whether a pressure sensor is correctly detecting a pressure value, the internal combustion engine being mounted on a vehicle, an exhaust passage of the internal combustion engine being provided with a filter for trapping particulate matter in exhaust gas in the exhaust passage, a pressure pipe being connected to an upstream section of the exhaust passage with respect to the filter and a downstream section of the exhaust passage with respect to the filter, and the pressure sensor being disposed in the pressure pipe and configured to detect, as the pressure value, a differential pressure between a pressure of the upstream section and a pressure of the downstream section; calculating, by the processing circuitry, a reference ratio when it is determined that the pressure sensor is correctly detecting the pressure value, the reference ratio being a ratio between the pressure value detected by the pressure sensor and a reference pressure that is a reference value of the pressure value, the reference pressure being calculated based on an operating parameter relating to the pressure value; storing the reference ratio as a value to be used in a next trip of the vehicle, the next trip being a trip subsequent to the trip in which the reference ratio is stored; calculating, by the processing circuitry, the reference pressure based on the operating parameter in the next trip; and calculating, by the processing circuitry, the pressure value by multiplying the calculated reference pressure by the stored reference ratio.

In a further general aspect, the present disclosure provides a non-transitory computer-readable storage medium that stores a program code for causing a processor to execute a control processes for an internal combustion engine similar to those in the above-described method.

According to these configurations, it is possible to obtain a highly accurate calculated value of a pressure value.

However, when a failure occurs in the pressure sensor or when the pressure pipe becomes clogged, the pressure sensor may be unable to correctly detect the pressure value. Accordingly, it is desirable, whenever possible, to use a calculated value as the pressure value. In order to perform appropriate control, it is also required that the pressure value, as a calculated value, be obtained with high accuracy. The above-described configurations contribute to achieving this objective.

Other features and aspects will be apparent from the following detailed description, the drawings, and the claims.

### BRIEF DESCRIPTION OF THE DRAWINGS

FIG. 1 is a schematic diagram showing the configuration of an internal combustion engine in which a controller according to a first embodiment is employed.

FIG. 2 is a flowchart illustrating a procedure of processes executed by processing circuitry according to the first embodiment.

FIG. 3 is a flowchart illustrating a procedure of processes executed by the processing circuitry according to the first embodiment.

FIG. 4 is a flowchart illustrating a procedure of processes executed by processing circuitry according to a second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

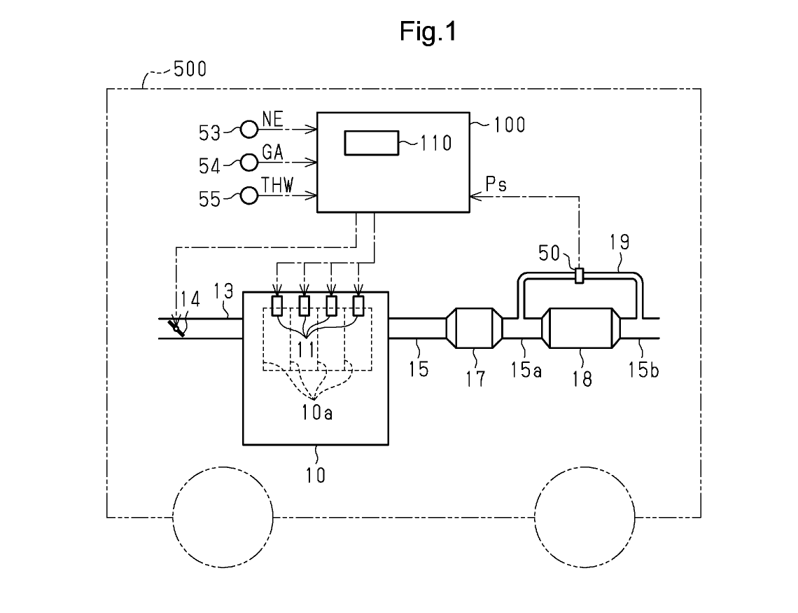

FIGS. 1-3 illustrate a first embodiment of the present disclosure. The first embodiment relates to a controller, a control method, a control process, a storage medium, a program product, and a program for an internal combustion engine 10. In the present embodiment, upstream refers to the upstream side in the direction of exhaust gas flow. Downstream refers to the downstream side in the direction of exhaust gas flow.

### Configuration of the Internal Combustion Engine

As shown in FIG. 1, the internal combustion engine 10 is mounted on a vehicle 500 and includes multiple cylinders 10a. An intake passage 13 is connected to an intake port of each of the cylinders 10a. The intake passage 13 includes a throttle valve 14 that adjusts an intake air amount.

Combustion chambers of the cylinders 10a are each provided with a fuel injection valve 11. In the combustion chamber of each cylinder 10a, an air-fuel mixture is ignited by spark discharge and burned. Air is taken into the combustion chamber through the intake passage 13. Fuel is injected from the fuel injection valve 11 into the combustion chamber. Exhaust gas produced by combustion of the air-fuel mixture in the combustion chambers is discharged to an exhaust passage 15 connected to an exhaust port of the internal combustion engine 10.

The exhaust passage 15 includes a three-way catalyst 17. The three-way catalyst 17 oxidizes hydrocarbon (HC) and carbon monoxide (CO) contained in the exhaust gas to produce water and carbon dioxide. The three-way catalyst 17 reduces nitrogen oxides (NOx) contained in the exhaust gas to produce nitrogen.

A gasoline particulate filter (hereinafter referred to as GPF) 18 is provided in the exhaust passage 15 downstream of the three-way catalyst 17. The GPF 18 includes a filter that traps particulate matter (also referred to as PM) in the exhaust gas, and a three-way catalyst supported by the filter.

The exhaust passage 15 is provided with a pressure pipe 19 connected to an upstream section and a downstream section of the exhaust passage 15 with respect to the GPF 18. Specifically, the exhaust passage 15 includes an upstream exhaust section 15a upstream of the GPF 18 and a downstream exhaust section 15b downstream of the GPF 18. The pressure pipe 19 is connected to the upstream exhaust section 15a and the downstream exhaust section 15b. The pressure pipe 19 is provided with a pressure sensor 50. The pressure sensor 50 detects, as a pressure value, a differential pressure between the upstream exhaust section 15a and the downstream exhaust section 15b. In other words, the pressure sensor 50 detects the differential pressure between an upstream exhaust pressure and a downstream exhaust pressure of the exhaust passage 15 with respect to the GPF 18. The upstream exhaust pressure is the pressure of the upstream exhaust section 15a, and the downstream exhaust pressure is the pressure of the downstream exhaust section 15b. The pressure sensor 50 outputs the detected pressure value as a pressure sensor value Ps.

The controller 100 includes processing circuitry 110. The processing circuitry 110 includes a CPU that executes processes in accordance with programs and memory that stores the programs and various values. The CPU executes programs or program codes stored in the memory to perform various types of controls.

The controller 100 receives detection signals from various types of sensors. Such various types of sensors include a crank angle sensor 53 provided near the crankshaft of the internal combustion engine 10. An engine rotation speed NE of the internal combustion engine 10 is calculated based on a detection signal of the crank angle sensor 53. The various types of sensors of the internal combustion engine 10 also include an air flow meter 54, which detects an intake air amount GA, and a coolant temperature sensor 55, which detects a coolant temperature THW (a temperature of coolant of the internal combustion engine 10).

The controller 100 executes various types of control related to the GPF 18. Examples of the various types of control as filter control include, for example, regeneration control of the GPF 18 and control for determining a structural loss abnormality of the GPF. An example of the filter regeneration control is control that increases an exhaust gas temperature so as to burn and remove PM deposited in the GPF 18 when a pressure value, which is the above-described differential pressure, becomes greater than or equal to a prescribed threshold. An example of the abnormal loss determination control for the GPF is control that, when the pressure value, which is the above-described differential pressure, becomes less than or equal to another prescribed threshold, determines that a structural-loss abnormality has occurred in the GPF and issues a warning notification.

### Process of Calculating the Pressure Value

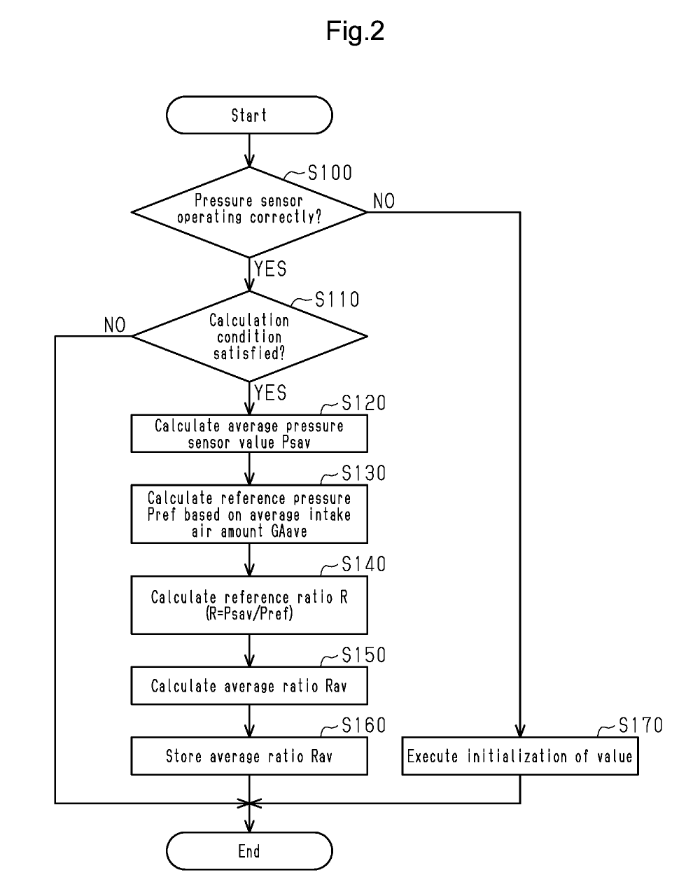

FIG. 2 shows a procedure of a process executed by the processing circuitry 110 of the controller 100. This process is repeatedly executed at specified intervals during a single trip from when the main switch of the vehicle 500 is turned on to when it is turned off. A single trip of the vehicle 500 is from when the main switch of the vehicle 500 is turned on to when it is turned off. In the following description, the number of each step is represented by the letter S followed by a numeral.

In the series of processes shown in FIG. 2, the processing circuitry 110 first executes a determination process of determining whether the pressure sensor 50 is operating correctly (S100). That is, the determination process determines whether the pressure sensor 50 is correctly detecting a pressure value P. In the process of S100, the processing circuitry 110 determines whether the pressure sensor 50 is operating correctly, for example, in the following manner. During operation of the internal combustion engine 10, the pressure of the exhaust passage 15 fluctuates. Accordingly, if the pressure sensor 50 is operating correctly, the pressure sensor value Ps fluctuates in accordance with the pressure fluctuations in the exhaust passage 15. When detecting fluctuations of the pressure sensor value Ps, which correspond to pressure fluctuations in the exhaust passage 15, within a prescribed determination period, the processing circuitry 110 determines that the pressure sensor 50 is operating correctly. When such fluctuations in the pressure sensor value Ps are not detected, the processing circuitry 110 determines that the pressure sensor 50 is not operating correctly.

When it is determined that the pressure sensor 50 is operating correctly in the process of S100 (S100: YES), the processing circuitry 110 determines whether the condition for calculating a reference ratio R is satisfied (S110). The reference ratio R will be described later. In step S110, when a state in which the intake air amount GA is greater than or equal to a prescribed threshold GAref continues for a prescribed time T or longer, the processing circuitry 110 determines that the condition for calculating the reference ratio R is satisfied. The threshold GAref and the prescribed time T are preset to values necessary for properly calculating the reference ratio R. Examples of values suitable for the threshold GAref and the prescribed time T, which are necessary for properly calculating the reference ratio R, include values that allow for determination that the intake air amount GA has remained relatively large for a certain duration.

In the process of S110, when it is determined that the calculation condition for the reference ratio R is satisfied (S110: YES), the processing circuitry 110 calculates an average pressure sensor value Psav (S120). The average pressure sensor value Psav is an average value of the pressure sensor value Ps detected by the pressure sensor 50 over a prescribed period TP.

Next, the processing circuitry 110 calculates a reference pressure Pref based on an average intake air amount GAave (S130). The average intake air amount GAave is an average value of the intake air amount GA detected by the air flow meter 54 over the prescribed period TP. As the intake air amount GA increases, the differential pressure between the upstream exhaust pressure and the downstream exhaust pressure with respect to the GPF 18 increases. Accordingly, in the present embodiment, the intake air amount GA is employed as an operating parameter that relates to the pressure value P, which represents the differential pressure.

The reference pressure Pref is a reference value of the pressure value P. The reference pressure Pref is calculated based on the intake air amount GA, which is an operating parameter relating to the pressure value P. For example, the correspondence between the intake air amount GA and the pressure value P is obtained in advance for a state of the GPF 18 in which a PM accumulation amount is 0. Data or a calculation formula indicating the correspondence between the intake air amount GA and the pressure value P is stored in memory. By referring to the data or calculation formula stored in the memory, the processing circuitry 110 calculates the reference pressure Pref corresponding to the intake air amount GA. As the intake air amount GA increases, the value of the reference pressure Pref increases.

Next, the processing circuitry 110 calculates the reference ratio R (S140). The reference ratio R is a ratio between the average pressure sensor value Psav and the reference pressure Pref; that is, R = Psav/Pref. In the process of S140, the processing circuitry 110 calculates the reference ratio R by assigning to the reference ratio R a value obtained by dividing the average pressure sensor value Psav by the reference pressure Pref.

When the PM accumulation amount in the GPF 18 provided in the exhaust passage 15 is 0, the reference ratio R is 1, which is the minimum value. In contrast, even if the intake air amount GA is held constant, the pressure loss of the GPF 18 increases as the PM accumulation amount in the GPF 18 increases. Accordingly, even if the intake air amount GA is held constant, the pressure sensor value Ps of the pressure sensor 50 increases as the PM accumulation amount in the GPF 18 increases. The value of the reference ratio R increases as the PM accumulation amount increases and thus the pressure loss in the GPF 18 increases.

Next, the processing circuitry 110 calculates an average ratio Rav (S150). The average ratio Rav is a moving average value of the reference ratio R. Specifically, the average ratio Rav is a value obtained by dividing, by (n + 1), the sum of the reference ratio R calculated in the current processing cycle and each reference ratio R calculated at specified intervals in each of the previous n processing cycles during the trip of the vehicle 500. The value of n is appropriate for calculating the average ratio Rav.

After calculating the average ratio Rav, the processing circuitry 110 stores the calculated average ratio Rav in the memory (S160). The average ratio Rav stored in the memory is not used in the current trip of the vehicle 500 but is used in the next trip. In the process of S160, the average ratio Rav is overwritten and stored. Therefore, when the process of S160 is executed, the value of the average ratio Rav stored in the memory is updated to the latest value calculated in the current process of S150.

In the process of S100, when it is determined that the pressure sensor 50 is not operating correctly (S100: NO), that is, when it is determined that the pressure sensor 50 is not correctly detecting the pressure value P, the processing circuitry 110 initializes the reference ratio R (S170). That is, in the process of S170, the processing circuitry 110 assigns 0, which is an initial value, to both the reference ratio R and the average ratio Rav. The current value of the average ratio Rav stored in the memory is maintained.

In a case in which the process of S160 or the process of S170 is executed, or in a case in which a negative determination is made in the process of S110, the processing circuitry 110 ends the execution of this process in the current cycle.

The processes from S120 to S160 correspond to a reference ratio storing process.

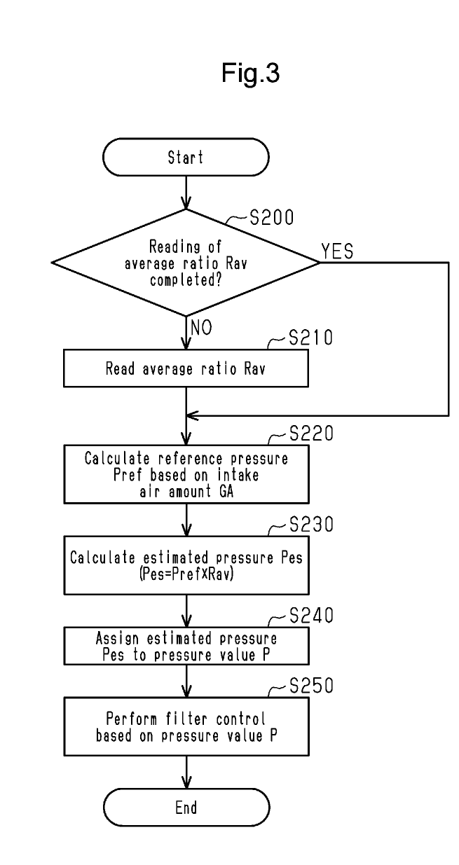

FIG. 3 shows a procedure of a pressure value calculation process for calculating the pressure value P. The pressure value calculation process is executed by the processing circuitry 110 of the controller 100. The pressure value calculation process is repeatedly executed at specified intervals during a single trip of the vehicle 500. A single trip of the vehicle 500 is from when the main switch is turned on to when it is turned off.

In the series of processes illustrated in FIG. 3, first, the processing circuitry 110 determines whether reading of the average ratio Rav has been completed (S200).

When it is determined that the reading of the average ratio Rav has not been completed (S200: NO), the processing circuitry 110 reads the value of the average ratio Rav (S210). The value of the average ratio Rav read from the memory at this time is a value that has been stored in the memory as a result of execution of the series of processes shown in FIG. 2. In other words, the value of the average ratio Rav read from the memory is a value that has been calculated in the previous trip of the vehicle 500. More specifically, in the previous trip, the average ratio Rav is stored while overwriting the previously stored value. Accordingly, the value of the average ratio Rav that the processing circuitry 110 reads in step S210 is the average ratio Rav last stored in the previous trip. In other words, the value of the average ratio Rav read in step S210 is the latest value of the average ratio Rav.

After the process of S210 is executed, or when an affirmative determination is made in the process of S200, the processing circuitry 110 calculates the reference pressure Pref based on the current intake air amount GA (S220). The calculation of the reference pressure Pref in the process of S220 is the same as the calculation of the reference pressure Pref in the process of S130. That is, the processing circuitry 110 calculates the reference pressure Pref corresponding to the intake air amount GA by referencing the data stored in the memory or the calculation formula.

Next, the processing circuitry 110 calculates an estimated pressure Pes (S230). The estimated pressure Pes is a calculated value of the pressure value P. Specifically, the processing circuitry 110 multiplies the reference pressure Pref, calculated in the process of S220, by the average ratio Rav, read in the process of S210. The processing circuitry 110 assigns the value of the product of the multiplication to the estimated pressure Pes. In this manner, the processing circuitry 110 calculates the estimated pressure Pes.

Next, the processing circuitry 110 assigns the calculated estimated pressure Pes to the pressure value P (S240).

Then, the processing circuitry 110 executes the above-described filter control based on the pressure value P to which the estimated pressure Pes is assigned (S250).

Thereafter, the processing circuitry 110 ends the execution of the present process in the current cycle.

### Operation and Advantages of the Present Embodiment

(1-1) The processing circuitry 110 executes the determination process. The determination process determines whether the pressure sensor 50 is correctly detecting a pressure value that is the differential pressure between the upstream exhaust pressure and the downstream exhaust pressure with respect to the GPF 18.

The processing circuitry 110 executes the reference ratio storing process. The reference ratio storing process calculates the reference ratio R and stores the reference ratio R as a value to be used in the next trip of the vehicle 500. The reference ratio R is a ratio between the reference pressure Pref and the pressure sensor value Ps of the pressure value detected by the pressure sensor 50 when it is determined that the pressure sensor 50 is correctly detecting the pressure value in the determination process. The reference pressure Pref is calculated based on an operating parameter relating to the pressure value.

In a trip of the vehicle 500 subsequent to the trip in which the reference ratio R has been stored, the processing circuitry 110 calculates the reference pressure Pref based on an operating parameter that influences the pressure value. The processing circuitry 110 executes the pressure value calculation process of calculating the estimated pressure Pes, which is a calculated value of the pressure value P, by multiplying the stored reference ratio R by the calculated reference pressure Pref.

Accordingly, the reference ratio R is calculated based on the pressure sensor value Ps, which is the pressure value detected by the pressure sensor 50 when it is determined that the pressure sensor 50 is correctly detecting the pressure value, and the reference pressure Pref, which is calculated based on the operating parameter relating to the pressure value.

The pressure loss of the GPF 18 varies in accordance with the PM accumulation amount in the GPF 18. Since the pressure value detected by the pressure sensor 50 varies in accordance with the pressure loss of the GPF 18, the value of the reference ratio R depends on the pressure loss of the GPF 18. In a vehicle trip in which the reference ratio R has been calculated, the pressure value P during the trip of the vehicle 500 is calculated based on the reference ratio R calculated in advance in the previous trip and the reference pressure Pref calculated based on the operating parameter relating to the pressure value. In other words, in the present embodiment, the pressure value P during a vehicle trip is calculated using the reference ratio R and the reference pressure Pref. The reference ratio R is a value calculated in advance when the pressure sensor 50 is correctly detecting the pressure value. The reference ratio R is a value corresponding to the pressure loss of the GPF 18. Therefore, in the trip subsequent to the trip in which the reference ratio R is calculated, a calculated value of the pressure value P can be obtained with high accuracy even if the pressure sensor 50 cannot correctly detect a pressure value.

(1-2) The reference ratio R stored in the reference ratio storing process is a moving average value of the reference ratio R calculated at specified intervals during a trip of the vehicle 500. Accordingly, it is possible to store the reference ratio R corresponding to the pressure loss of the GPF 18 at the end of the trip of the vehicle 500, while suppressing variations in the calculated reference ratio R.

(1-3) When it is determined in the determination process that the pressure sensor 50 is not correctly detecting the pressure value, the processing circuitry 110 executes the initialization process for the reference ratio R and the average ratio Rav. The average ratio Rav is a moving average value of the reference ratio R. Accordingly, it is possible to prevent the reference ratio R and the average ratio Rav from being calculated based on an erroneous pressure value.

(1-4) In the reference ratio storing process, the reference ratio R is calculated based on the reference pressure Pref and the average value of the pressure sensor value Ps. The pressure sensor value Ps has been detected by the pressure sensor 50 within the prescribed period TP. The reference pressure Pref is calculated based on an average value of the operating parameter over the prescribed period TP.

Accordingly, the reference ratio R is not adversely affected by fluctuations of the pressure sensor value Ps detected by the pressure sensor 50 and fluctuations of the operating parameter for calculating the reference pressure Pref.

(1-5) As the intake air amount GA increases, the differential pressure between the upstream exhaust pressure and the downstream exhaust pressure with respect to the GPF 18 increases. Accordingly, in the present embodiment, the intake air amount GA is used as the operating parameter relating to the pressure value. Therefore, the reference pressure Pref is properly calculated.

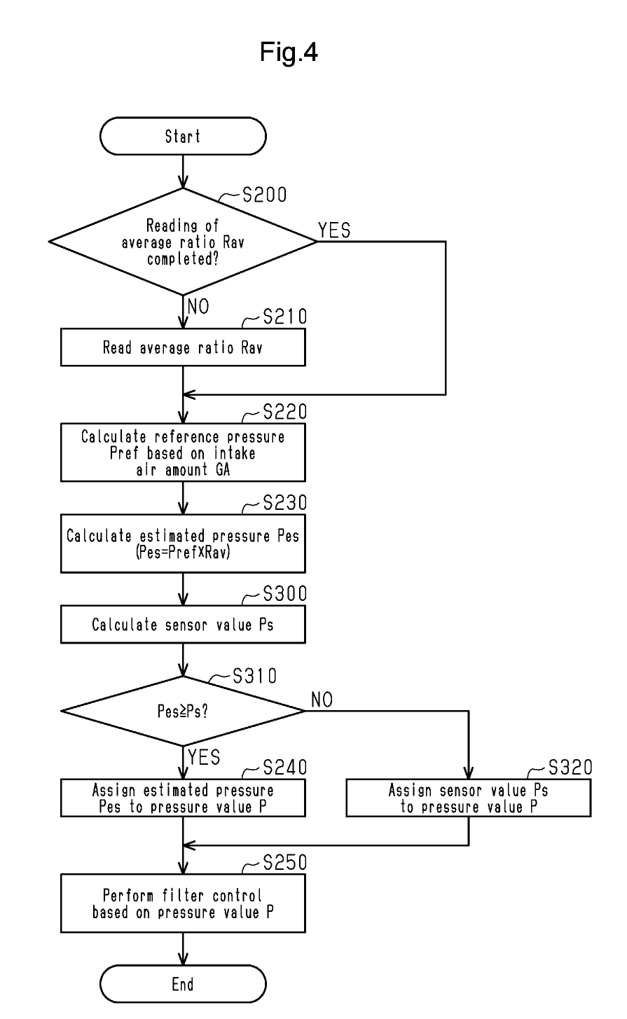

FIG. 4 illustrates a second embodiment according to the present disclosure. The second embodiment is different from the first embodiment in a part of the series of processes shown in FIG. 3. The present embodiment will be described focusing on the difference.

FIG. 4 illustrates a procedure of a process executed by the processing circuitry 110 according to the present embodiment. In FIG. 4, the same step numbers are given to the processes that are the same as those in FIG. 3.

In the series of processes shown in FIG. 4, the processing circuitry 110 calculates the estimated pressure Pes by executing the processes of S200 to S230 described above.

When the estimated pressure Pes is calculated in the process of S230, the processing circuitry 110 acquires the current pressure sensor value Ps of the pressure sensor 50 (S300). The process of S300 is executed when the pressure sensor 50 is correctly detecting the pressure value. When the pressure sensor 50 is not correctly detecting the pressure value, the processing circuitry 110 assigns, for example, 0 to the pressure sensor value Ps.

Next, the processing circuitry 110 determines whether the estimated pressure Pes is greater than or equal to the pressure sensor value Ps (S310). When it is determined that the estimated pressure Pes is greater than or equal to the pressure sensor value Ps (S310: YES), the estimated pressure Pes is greater than the pressure sensor value Ps, or the estimated pressure Pes is equal to the pressure sensor value Ps. In this case, the processing circuitry 110 assigns the estimated pressure Pes to the pressure value P (S240).

When it is determined that the estimated pressure Pes is not greater than or equal to the pressure sensor value Ps in the process of S310 (S310: NO), the pressure sensor value Ps is greater than the estimated pressure Pes. In this case, the processing circuitry 110 assigns the pressure sensor value Ps to the pressure value P (S320).

After executing one of the process of S240 or the process of S320, the processing circuitry 110 executes the process of S250. In the process of S250, the processing circuitry 110 executes the above-described filter control based on the pressure value P to which a value has been assigned by one of the process of S240 or the process of S320.

Thereafter, the processing circuitry 110 ends the execution of the present process in the current cycle.

### Operation and Advantages of the Present Embodiment

The present embodiment has the following advantage in addition to the advantages (1-1), (1-2), (1-3), (1-4), and (1-5).

(2-1) The processing circuitry 110 executes the control related to the GPF 18, which is a filter, based on the greater one of the estimated value Pes or the pressure sensor value Ps. The estimated pressure Pes of the pressure value P is calculated in the above-described pressure value calculation process. The pressure sensor value Ps is the pressure value P detected by the pressure sensor 50.

Accordingly, when the differential pressure between the upstream exhaust pressure and the downstream exhaust pressure with respect to the GPF 18 becomes unexpectedly high during a trip of the vehicle 500, the control related to the GPF 18 is executed using the higher one of the estimated pressure Pes and the pressure sensor value Ps. The estimated pressure Pes is a calculated value of the pressure value P. Therefore, it is possible to cope with an excessively high pressure state.

### Modifications

The above-described embodiments may be modified as follows. The above-described embodiments and the following modifications can be combined as long as the combined modifications remain technically consistent with each other.

Although the moving average value of the reference ratio R is calculated, another average value may be calculated. Further, such calculation of average values does not necessarily need to be performed. In this case, the advantages except for advantage (1-2) are obtained.

When it is determined in the determination process that the pressure sensor 50 is not correctly detecting the pressure value, the initialization process of the reference ratio R and the average ratio Rav is performed. However, such initialization does not necessarily need to be performed. In this case, the advantages except for advantage (1-3) are obtained.

The reference pressure Pref is calculated based on the average value of the operating parameter, and the reference ratio R is calculated based on the reference pressure Pref and the average pressure sensor value Psav. The average pressure sensor value Psav is an average value of the pressure sensor value Ps detected by the pressure sensor 50. However, such calculation of average values does not necessarily need to be performed. In this case, the advantages except for advantage (1-4) are obtained.

Although the intake air amount GA is used as the operating parameter relating to the pressure value, another operating parameter may be used.

The reference value Pref is calculated based on the correspondence between the intake air amount GA and the reference value P in the GPF 18 in which the PM accumulation amount is 0. In addition, a correspondence between the intake air amount GA and the pressure value P in the GPF 18 when the PM accumulation amount is a prescribed amount greater than 0 is obtained in advance. Data or a calculation formula indicating the correspondence is stored in memory. The processing circuitry 110 may calculate the reference pressure Pref corresponding to the intake air amount GA by referring to the data or calculation formula stored in the memory. In this modification, when the PM accumulation amount in the GPF 18 is larger than the prescribed amount, the reference ratio R is greater than 1. When the PM accumulation amount in the GPF 18 is less than the prescribed amount, the reference ratio R is less than 1.

In the process of S160 illustrated in FIG. 2, the processing circuitry 110 overwrites and stores the calculated average ratio Rav in the memory. In addition, the processing circuitry 110 does not necessarily need to delete the average ratio Rav already stored in the memory by overwriting the average ratio Rav calculated in a single trip on the memory, but may store all values of the average ratio Rav of the respective trips in the memory without deleting the stored values of average ratio Rav. In this case, when executing the pressure value calculation process shown in FIG. 3, the processing circuitry 110 may read the average ratio Rav that was stored last in the previous trip; that is, the latest value of the average ratio Rav.

The position of the GPF 18 in the exhaust passage 15 can be changed as appropriate.

The GPF 18 may be a filter that does not support a three-way catalyst.

The controller 100 is not limited to a device that includes a CPU and a memory module and executes software processing. For example, the controller 100 may include hardware circuits, for example, an application-specific integrated circuit (ASIC)), dedicated to executing at least part of the processes executed by the software in the above-described embodiment. That is, the controller 100 may be modified as long as it includes processing circuitry that has any one of the following configurations (a) to (c). (a) Processing circuitry including one or more processors that execute all of the above-described processes according to programs and one or more program storage devices such as ROMs that store the programs. (b) Processing circuitry including one or more processors and one or more program storage devices that execute part of the above-described processes according to the programs and one or more dedicated hardware circuits that execute the remaining processes. (c) Processing circuitry including one or more dedicated hardware circuits that execute all of the above-described processes. The program storage device, which is a non-transitory computer-readable storage medium, includes any type of medium that is accessible by general-purpose computers or dedicated computers.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for an internal combustion engine, the controller comprising processing circuitry, the processing circuitry being configured to execute:
a determination process of determining whether a pressure sensor is correctly detecting a pressure value, the internal combustion engine being mounted on a vehicle, an exhaust passage of the internal combustion engine being provided with a filter for trapping particulate matter in exhaust gas in the exhaust passage, a pressure pipe being connected to an upstream section of the exhaust passage with respect to the filter and a downstream section of the exhaust passage with respect to the filter, and the pressure sensor being disposed in the pressure pipe and configured to detect, as the pressure value, a differential pressure between a pressure of the upstream section and a pressure of the downstream section;
a reference ratio storing process of calculating a reference ratio and storing the reference ratio as a value to be used in a next trip of the vehicle when it is determined in the determination process that the pressure sensor is correctly detecting the pressure value, the next trip being a trip subsequent to the trip in which the reference ratio is stored, the reference ratio being a ratio between the pressure value detected by the pressure sensor and a reference pressure that is a reference value of the pressure value, the reference pressure being calculated based on an operating parameter relating to the pressure value; and
a pressure value calculation process including: calculating the reference pressure based on the operating parameter in the next trip; and calculating the pressure value by multiplying the calculated reference pressure by the stored reference ratio.

2. The controller for the internal combustion engine according to claim 1, wherein the reference ratio stored in the reference ratio storing process is a moving average value of the reference ratio calculated at specified intervals during a trip of the vehicle.

3. The controller for the internal combustion engine according to claim 1, wherein the processing circuitry is configured to initialize the reference ratio when it is determined in the determination process that the pressure sensor is not correctly detecting the pressure value.

4. The controller for the internal combustion engine according to claim 1, wherein the reference ratio storing process calculates the reference ratio based on
an average value, over a prescribed period, of the pressure values detected by the pressure sensor, and
the reference pressure calculated based on an average value, over the prescribed period, of the operating parameter.

5. The controller for the internal combustion engine according to claim 1, wherein the operating parameter is an intake air amount.

6. The controller for the internal combustion engine according to claim 1, wherein
the processing circuitry is configured to perform a control related to the filter based on a greater one of
the pressure value calculated in the pressure value calculation process, or
the pressure value detected by the pressure sensor.

7. A method for controlling an internal combustion engine, the method comprising:
determining, by processing circuitry of a controller, whether a pressure sensor is correctly detecting a pressure value, the internal combustion engine being mounted on a vehicle, an exhaust passage of the internal combustion engine being provided with a filter for trapping particulate matter in exhaust gas in the exhaust passage, a pressure pipe being connected to an upstream section of the exhaust passage with respect to the filter and a downstream section of the exhaust passage with respect to the filter, and the pressure sensor being disposed in the pressure pipe and configured to detect, as the pressure value, a differential pressure between a pressure of the upstream section and a pressure of the downstream section;
calculating, by the processing circuitry, a reference ratio when it is determined that the pressure sensor is correctly detecting the pressure value, the reference ratio being a ratio between the pressure value detected by the pressure sensor and a reference pressure that is a reference value of the pressure value, the reference pressure being calculated based on an operating parameter relating to the pressure value;
storing the reference ratio as a value to be used in a next trip of the vehicle, the next trip being a trip subsequent to the trip in which the reference ratio is stored;
calculating, by the processing circuitry, the reference pressure based on the operating parameter in the next trip; and
calculating, by the processing circuitry, the pressure value by multiplying the calculated reference pressure by the stored reference ratio.

8. A non-transitory computer-readable storage medium that stores a program code for causing a processor to execute a control process for an internal combustion engine, the control process includes:
determining, by processing circuitry of the processor, whether a pressure sensor is correctly detecting a pressure value, the internal combustion engine being mounted on a vehicle, an exhaust passage of the internal combustion engine being provided with a filter for trapping particulate matter in exhaust gas in the exhaust passage, a pressure pipe being connected to an upstream section of the exhaust passage with respect to the filter and a downstream section of the exhaust passage with respect to the filter, and the pressure sensor being disposed in the pressure pipe and configured to detect, as the pressure value, a differential pressure between a pressure of the upstream section and a pressure of the downstream section;
calculating, by the processing circuitry, a reference ratio when it is determined that the pressure sensor is correctly detecting the pressure value, the reference ratio being a ratio between the pressure value detected by the pressure sensor and a reference pressure that is a reference value of the pressure value, the reference pressure being calculated based on an operating parameter relating to the pressure value;
storing the reference ratio as a value to be used in a next trip of the vehicle, the next trip being a trip subsequent to the trip in which the reference ratio is stored;
calculating, by the processing circuitry, the reference pressure based on the operating parameter in the next trip; and
calculating, by the processing circuitry, the pressure value by multiplying the calculated reference pressure by the stored reference ratio.
